(19) United States
(12) Patent Application Publication
(10) Pub. No.: US 2010/0122761 A1
(43) Pub. Date: May 20, 2010

(54) Heavy Load Pneumatic Tire

(75) Inventor: Akinori Miyake, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/567,820

(22) Filed: Sep. 28, 2009

(30) Foreign Application Priority Data
Nov. 17, 2008 (JP) 2008-293696

(51) Int. Cl. B60C 3/04

(52) U.S. Cl. 152/454

(57) ABSTRACT

A belt layer of the heavy load pneumatic tire includes a first reinforcement belt, a first function belt, a second reinforcement belt, and a second function belt, and when defining, as viewed in the width direction of the tire, the length from the outer end of the first reinforcement belt to a tire equator as “Wᵣₛ”, the length from the outer end of the function belt having the shorter length in the first and second function belts to the tire equator as “W_{w}”, and the length from the outer end of the second reinforcement belt to the tire equator as “Wᵣ”, the lengths are set so as to be Wᵣ<Wᵣₛ<W_{w}.

### BACKGROUND OF THE INVENTION

1. Field of the Invention

The present invention relates to a heavy load pneumatic tire that includes a carcass layer with both ends rolled back at a pair of circular beads and a belt layer disposed outside of the carcass layer as viewed in a radial direction of the tire so as to reinforce the carcass layer, and is increased in both of durability of the belt layer and anti irregular wear performance.

2. Description of the Related Art

Recently, in vehicles such as, for example, trucks and buses mounted with heavy load pneumatic tires, tires of small diameter and small flattening ratio are increasingly used in order to increase a space of a baggage chamber and/or to lower a floor. Generally, in heavy load pneumatic tires, a binding force of a belt layer maintains the shape the tire. In tires of low flattering, which are increasingly used in these days, belt layer of conventional belt structure is insufficient in binding force. Therefore, tread portion of the tire expands in the outer diameter. Particularly, the outer diameter of tread shoulder portion largely expands during traveling. As a result, ground-contact pressure in the tread shoulder portion increases causing irregular wear of the tire and layer peeling in a belt end portion. Thus, the durability of the belt layer tends to decrease. In view of the above circumstances, there have been proposed such heavy load pneumatic tires in which a reinforcement belt having belt cords arranged in a circumferential direction of the tire is disposed to thereby increase the binding force of the entire belt layer.

Japanese Unexamined Patent Publication Nos. 11-502166 and 2000-504655 disclose the following pneumatic tire. Specifically, the pneumatic tire provided with an additional belt ply having belt cords arranged substantially parallel to the circumferential direction of the tire and being disposed between two function belt plies each of which has belt cords arranged at an angle of 10 to 45° with respect to a circumferential direction of the tire. However, in the pneumatic tires disclosed in Japanese Unexamined Patent Publication Nos. 11-502166 and 2000-504655, substantially the entire of the tread portion is covered by the additional belt ply. Therefore, not only in the tread shoulder portion the outer diameter of which largely expands during traveling but also in tread center portion, the binding force of the belt layer is uniformly increased. As a result, the outer diameter of the tread shoulder portion still expands exceeding the expansion in the outer diameter of the tread center portion. Therefore, in these pneumatic tires, ground-contact pressure in the tread shoulder portion increases and tends to cause irregular wear. Furthermore, in the pneumatic tires disclosed in Japanese Unexamined Patent Publication Nos. 11-502166 and 2000-504655, in the tread shoulder portion, the binding force of the belt layer is still insufficient and tends to cause layer peeling in the end portion of the belt ply.

Japanese Unexamined Patent Publication No. 2007-176438 discloses the following heavy load radial tire. Specifically, the heavy load radial tire includes a first belt ply which has belt cords arranged at an angle of 10 to 45° with respect to the circumferential direction of the tire, a third belt ply which is disposed outside of the first belt ply as viewed in the radial direction of the tire and has belt cords arranged at an angle of 10 to 45° with respect to the circumferential direction of the tire, a second belt ply which is disposed between the first belt ply and the third belt ply and has belt cords arranged at an angle of 5° or less with respect to the circumferential direction of the tire, and a fourth belt ply which is disposed outside of the third belt ply as viewed in the radial direction of the tire and has belt cords arranged at an angle of 5° or less with respect to the circumferential direction of the tire. However, in the tire disclosed in Japanese Unexamined Patent Publication No. 2007-176438, the binding force of the belt ply in the tread shoulder portion is insufficient. Therefore, ground-contact pressure of the tire is increased in the tread shoulder portion and the tire tends to cause irregular wear and/or layer peeling in the end portion of the belt ply.

Japanese Unexamined Patent Publication No. 06-32108 discloses the following flat tire, the flattening of which is 75% or less. The flat tire includes a carcass and a function belt layer of at least two or more layers which is disposed outside of the carcass as viewed in the radial direction of the tire and has belt cords preferably arranged at an angle of 10 to 30° with respect to the circumferential direction of the tire, wherein belt reinforcement layer of at least two layers having belt cords arranged in substantially parallel to the circumferential direction of the tire is provided between the carcass and the function belt layer. However, in the flat tire disclosed in Japanese Unexamined Patent Publication No. 06-32108, the belt reinforcement layer is not interposed between the function belt layers. Therefore, a relatively large tension is applied to the function belt layer and the uneven tension is applied to the entire of the function belt layer. Therefore, the tire tends to cause cord breakage in the function belt layer, peeling in the end area of the belt layer and irregular wear.

### SUMMARY OF THE INVENTION

The present invention has been proposed in view of the above circumstances. It is an object of the present invention to provide a heavy load pneumatic tire, in which both of the durability of a belt layer and the anti irregular wear performance can be increased.

The above object can be achieved by the present invention as described below. Specifically, a heavy load pneumatic tire according to the present invention includes a carcass layer with both ends rolled back at a pair of circular beads, and a belt layer disposed outside of the carcass layer as viewed in a radial direction of the tire so as to reinforce the carcass layer. The belt layer includes a first reinforcement belt that is located innermost thereof as viewed in a radial direction of the tire, is separated into two parts each of which is disposed at both sides of a tire equator and is spaced apart from each other, and has belt cords arranged in a circumferential direction of the tire, a first function belt that is disposed outside of the first reinforcement belt as viewed in the radial direction of the tire and has belt cords arranged at an angle of 10 to 30° with respect to the circumferential direction of the tire, a second reinforcement belt that is disposed outside of the first function belt as viewed in the radial direction of the tire and has belt cords arranged in the circumferential direction of the tire, and a second function belt that is disposed outside of the second reinforcement belt as viewed in the radial direction of the tire and has belt cords arranged at an angle of 10 to 30° with respect to the circumferential direction of the tire and in a direction opposite to an inclination direction of the belt cords of the first function belt, wherein, when defining, as viewed in the width direction of the tire, the length from the outer end of the first reinforcement belt to a tire equator as “Wᵣₛ”, the length from the outer end of the function belt having the shorter length in the first and second function belts to the tire equator as “W_{w}”, and the length from the outer end of the second reinforcement belt to the tire equator as “Wᵣ”, the lengths are set so as to be Wᵣ<Wᵣₛ<W_{w}. In the present invention, the wording “belt cords arranged in the circumferential direction of the tire” means the belt cords arranged at an angle of 5° or less with respect to the circumferential direction of the tire.

In the heavy load pneumatic tire, only the tread shoulder portion, the outer diameter of which expands largest in the tread portion and the largest tension is applied to the belt layer, is reinforced by the first reinforcement belt being separated into two parts each of which is disposed at the both sides of the tire equator and is spaced apart from each other. Therefore, the expansion in the outer diameter of the tread portion can be uniformly prevented to the minimum while reducing the total weight of the belt layer. As a result, in the heavy load pneumatic tire, irregular wear and layer peeling in belt layer end portion can be prevented.

In the heavy load pneumatic tire, when defining, as viewed in the width direction of the tire, the length from the outer end of the first reinforcement belt to the tire equator as “Wᵣₛ”, the length from the outer end of the function belt having the shorter length in the first and second function belts to the tire equator as “W_{w}”, and the length from outer end of the second reinforcement belt to the tire equator as “Wᵣ”, the lengths are set to be Wᵣ<Wᵣₛ<W_{w}. With this arrangement, as viewed in the width direction of the tire, both of the outer ends of the two reinforcement belts are disposed at the side inner than the outer ends of the function belts. Compared to a case where, as viewed in the width direction of the tire, the outer ends of the reinforcement belts are disposed at the side outer than the outer ends of the function belts, the belt cords can be prevented from being broken. Also, as viewed in the width direction of the tire, the outer end of the first reinforcement belt is located at a position between the outer end of the function belts and the outer end of the second reinforcement belt. Therefore, the tread shoulder portion can be reinforced by the first reinforcement belt while maintaining a certain distance between the outer end of the function belts and the outer end of the second reinforcement belt. With this arrangement, expansion of the outer diameter in the tread portion can be uniformly reduced to the minimum. Accordingly, irregular wear of the tire and layer peeling in the end area of the belt layer can be prevented.

When the first reinforcement belt being separated into two parts each of which is spaced apart from each other at the both sides of the tire equator, is interposed between the function belt and the reinforcement belt, or between two function belts, air is trapped between the belts and layer peeling tends to occur easily in the belt layer. However, in the heavy load pneumatic tire, the first reinforcement belt is disposed being divided into two parts at the innermost side of the belt layer in the radial direction of the tire as well as outside of the carcass as viewed in the radial direction of the tire. Therefore, air trapping in the belt layer can be prevented.

As described above, in the heavy load pneumatic tire, break of the belt cord and layer peeling in the end area of the belt layer can be prevented. Therefore, the durability of the belt layer can be increased, and at the same time, the anti irregular wear performance of the tire can be increased.

In the heavy load pneumatic tire, when defining, as viewed in the width direction of the tire, the length of the first reinforcement belt as “L₁”, the length is preferably set so as to be 0.3≦L₁/W_{w}≦0.6. By thus setting the length, in the heavy load pneumatic tire, the durability of the belt layer and the anti irregular wear performance can be further increased while reducing the total weight of the belt layer. In the present invention, the wording “the length of the first reinforcement belt as viewed in the width direction of the tire” means the length of one part of the first reinforcement belt in the width direction of the tire even though the first reinforcement belt has two parts each of which is disposed at the both sides of the tire equator and is spaced apart from each other.

In the heavy load pneumatic tire, it is preferable that the belt layer further includes a protection belt that is disposed at the outermost side thereof as viewed in the radial direction of the tire and has belt cords arranged at an angle of 10 to 30° with respect to the circumferential direction of the tire, the outer end of the protection belt as viewed in the width direction of the tire is located at the position outer than the main groove located at the outermost side of the tread portion as viewed in the width direction of the tire, and when defining, as viewed in the width direction of the tire, the length from the outer end of the protection belt to the tire equator as “Wₚ”, the length is preferably set so as to be Wₚ<Wᵣ. With this arrangement, the durability of the belt layer is considerably increased while reducing the total weight of the belt layer.

### BRIEF DESCRIPTION OF THE DRAWINGS

FIG. 1 illustrates an example of a cross-section of a heavy load pneumatic tire taken along a tire equator.

### DETAILED DESCRIPTION OF THE PREFERRED EMBODIMENTS

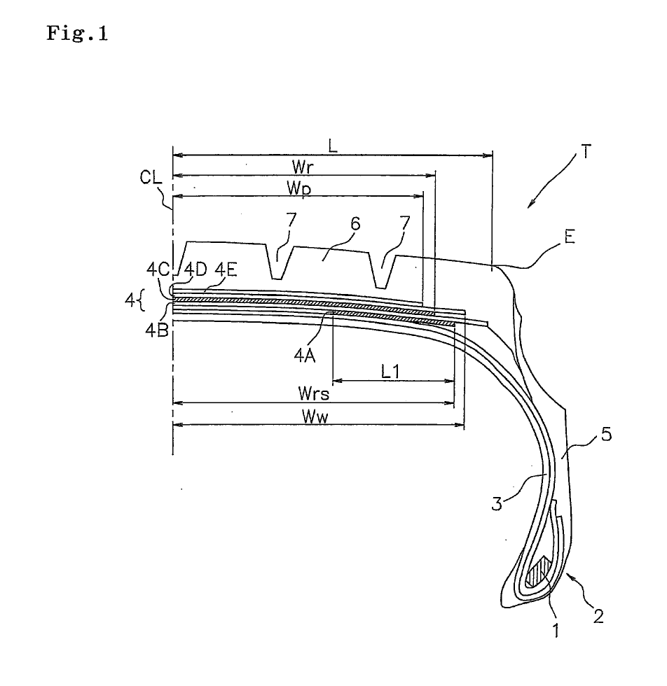

Embodiment of the present invention will be described below with reference to the drawing. FIG. 1 shows an example of a cross-section taken along a tire equator of a heavy load pneumatic tire according to the present invention.

A heavy load pneumatic tire T shown in FIG. 1 includes a pair of circular beads 2 each including a bead core 1, a carcass layer 3 both ends of which are rolled back at the pair of the circular beads 2, and a belt layer 4 that is disposed outside of the carcass layer 3 as viewed in a radial direction of the tire so as to reinforce the carcass layer 3. The heavy load pneumatic tire T has sidewall portions 5 extending outward from the pair of the circular beads 2 in the radial direction of the tire and a tread portion 6 connected to the sidewall portions 5.

The heavy load pneumatic tire T is formed with a plurality of main grooves 7 extending in a circumferential direction of the tire in the tread portion 6. In addition to the main grooves 7, the tread portion 6 may be formed with a plurality of lateral grooves and/or oblique grooves (not shown). A block pattern and/or rib pattern may be formed being segmented by the main grooves 7 and the lateral grooves or the like.

As an example, this embodiment describes the heavy load pneumatic tire T the flattening of which, defined as a ratio of a height to a width of the tire (height/width in tire section), is 60. According to the present invention, particularly in heavy load pneumatic tires with the flattening of 60 or less, both of durability and anti irregular wear performance of the belt layer can be increased.

The carcass layer 3 and the belt layer 4 have belt cords each arranged at a predetermined angle. As the materials constituting the belt cords, organic fibers such as polyester, rayon, nylon, aramid and the like; and further, metal such as steel and the like are preferably used. In these materials, particularly as a material constituting the belt cord of a reinforcement belt, a cord of metal such as steel and the like having a high belt binding force and a high break strength is preferred. In the present embodiment, the carcass layer 3 is disposed being bridged between the pair of circular beads 2 with both ends being rolled back. The carcass layer 3 is constituted of a sheet of carcass ply, in which the steel cords are arranged at an angle of about 90° with respect to a tire equator CL.

In the present embodiment, the belt layer 4 includes, from the inside as viewed in the radial direction of the tire, a first reinforcement belt 4A, a first function belt 4B, a second reinforcement belt 4C, a second function belt 4D and a protection belt 4E, which are built up in that order.

The first reinforcement belt 4A is located at the innermost side of the belt layer 4 as viewed in the radial direction of the tire. The first reinforcement belt 4A is separated into two parts at the both sides of the tire equator CL and is spaced apart from each other. The first reinforcement belt 4A has belt cords that are arranged in the circumferential direction of the tire. The first function belt 4B is disposed outside of the first reinforcement belt 4A as viewed in the radial direction of the tire. The first function belt 4B has belt cords arranged at an angle of 10 to 30° with respect to the circumferential direction of the tire. The second reinforcement belt 4C is disposed outside of the first function belt 4B as viewed in the radial direction of the tire. The second reinforcement belt 4C has belt cords arranged in the circumferential direction of the tire. The second function belt 4D is disposed outside of the second reinforcement belt 4C as viewed in the radial direction of the tire. The second function belt 4D has belt cords arranged at an angle of 10 to 30° with respect to the circumferential direction of the tire. The belt cords of the second function belt 4D is also arranged to be inclined in a direction opposite to the inclination direction of the belt cords of the first function belt 4B. The belt cords of the first function belt 4B and the second function belt 4D are preferably arranged at an angle of 17 to 20° with respect to the circumferential direction of the tire. The protection belt 4E is disposed at the outermost side of the belt layer 4 in the radial direction of the tire. The protection belt 4E has belt cords arranged at an angle of 10 to 30° with respect to the circumferential direction of the tire.

In the present invention, when defining, as viewed in a width direction of the tire, a length from the outer end of the first reinforcement belt 4A to the tire equator CL as “Wᵣₛ”, a length from the outer end of the function belt that has a shorter length to the tire equator CL in the first function belt 4B and the second function belt 4D as “W_{w}”, and a length from the outer end of the second reinforcement belt 4C to the tire equator CL as “Wᵣ”, the ratio among the three lengths is set to be Wᵣ<Wᵣₛ<W_{w}. With this arrangement, as viewed in the width direction of the tire, both of the outer ends of the first reinforcement belt 4A and the second reinforcement belt 4C are disposed at the side inner than the outer ends of the first function belt 4B and the second function belt 4D. As a result, as viewed in the width direction of the tire, compared to a case where the outer ends of the first reinforcement belt 4A and the second reinforcement belt 4C are disposed at the side outer than the outer ends of the first function belt 4B and the second function belt 4D, the belt cords can be prevented from being broken. Also, as viewed in the width direction of the tire, the outer end of the first reinforcement belt 4A is located at a position between the outer end of the first function belt 4B and the outer end of the second reinforcement belt 4C, and is located at a position between the outer end of the second function belt 4D and the outer end of the second reinforcement belt 4C as well. Therefore, as viewed in the width direction of the tire, a tread shoulder portion can be reinforced by the first reinforcement belt 4A while maintaining a certain distance between the outer end of the first function belt 4B and the outer end of the second reinforcement belt 4C and a certain distance between the outer end of the second function belt 4D and the outer end of the second reinforcement belt 4C. With this arrangement, expansion in the outer diameter in the tread portion 6 can be evenly reduced to the minimum. Therefore, irregular wear of the tire and layer peeling in the end of the belt layer 4 can be prevented in the heavy load pneumatic tire according to the present invention.

Moreover, in the tread portion 6, only the tread shoulder portion, where the outer diameter expands most and the largest tension is applied to the belt layer 4, is reinforced by the first reinforcement belt having two parts each of which is disposed at the both sides of the tire equator and is spaced apart from each other. Therefore, the expansion in the outer diameter can be uniformly prevented to the minimum in the entire of the tread portion 6, and the total weight of the belt layer 4 can be reduced. When defining the length from a ground-contact end E of the tread portion 6 to the tire equator CL as “L”, the length L is preferably set so as to be 0.7≦Wᵣ/L≦0.9 in order to reliably reinforce the tread shoulder portion. When the ratio Wᵣ/W_{w} is set so as to be 0.8≦Wᵣ/W_{w}≦0.95, the second reinforcement belt 4C preferably interposes reliably between the first function belt 4B and the second function belt 4D. In this case, the tension applied to the first function belt 4B and the second function belt 4D can be reduced, and the tension can be applied uniformly to the entire of the first function belt 4B and the second function belt 4D. As a result, the durability of the belt layer 4 and the anti irregular wear performance can be further increased.

In the present invention, the wording “ground-contact end E” means an outermost point of the tire that comes into contact with the ground of a plane road surface as viewed in the width direction of the tire when the tire assembled with a proper rim and filled with air at a proper inner pressure is placed vertically on the plane road surface and applied with a proper load. The wording “proper load” means here a maximum load (a designed normal load, in case of a tire for passenger car), and the wording “proper inner pressure” means here an air pressure appropriate thereto, which are specified by a standard such as JATMA, TRA, ETRTO, and the like corresponding to the application location and/or manufacturing location of the tire. The wording “proper rim” basically refers to a standard rim specified by JATMA, TRA, ETRTO and the like.

In addition, when defining, as viewed in the width direction of the tire, the length of the first reinforcement belt as “L₁”, and the length from the outer end of the function belt having the shorter length in the first function belt 4B and the second function belt 4D to the tire equator as “W_{w}”, the ratio is preferably set so as to be 0.3≦L₁/W_{w}≦0.6. With this arrangement, in the heavy load pneumatic tire T, the durability and the anti irregular wear performance of the belt layer 4 can be further increased as well as the total weight of the belt layer 4 can be reduced. When L₁/W_{w} is 0.3 or less, both of the durability and the anti irregular wear performance of the belt layer 4 tend to decrease. When L₁/W_{w} is 0.6 or more, the anti irregular wear performance of the tire tends to decrease.

The protection belt 4E is particularly disposed at the outermost side of the belt layer 4 as viewed in the radial direction of the tire so as to protect the belt layer 4 from damage caused from a crack generated at the bottom of the main groove 7 in the tread portion 6. On the other hand, when the entire of the belt layer 4 is covered by the protection belt 4E, it leads to an increase of the total weight of the belt layer 4. In the present embodiment, the outer end of the protection belt 4E as viewed in the width direction of the tire is located at the outermost position, which is outer than the main groove 7 of the tread portion 6. When defining the length from the outer end protection belt 4E to the tire equator CL as viewed in the width direction of the tire as “Wₚ”, the length is set so as to be Wₚ<Wᵣ. With this arrangement, the durability of the belt layer 4 can be particularly increased and, at the same time, the total weight of the belt layer 4 can be reduced.

When the reinforcement belt having the belt cords arranged in the circumferential direction of the tire is, as viewed in the radial direction of the tire, disposed at the side outer than the second function belt having the belt cords arranged at an angle of 10 to 30° with respect to the circumferential direction of the tire, the belt cords of the reinforcement belt may be broken. Therefore, like the present embodiment, the reinforcement belt is preferably not disposed at the outer side of the second function belt as viewed in the radial direction of the tire.

The pneumatic tire according to the present invention is the same as ordinal pneumatic tires except that the above-described belt layer is included. Therefore, known materials, shapes, structures, manufacturing methods and the like can be applicable to the present invention.

### EXAMPLES

Examples and Comparative Examples demonstrating the structure and effect of the present invention will be described below. Performance evaluation of the tires was made as described below using a test tire of 315/60R22.5.

### (1) Tire Weight

When defining the tire weight of the Comparative Example 1 as 100, the tires were evaluated using indexes. The larger index indicates the heavier tire weight.

### (2) Durability

After assembling the test tires to a wheel with rim size of 22.5×9.00, the air pressure was adjusted to 1,000 kPa, and running test was conducted on a drum (drum inside diameter: 1,700 mm) under the following conditions; i.e. speed: 40 km/h, load: 4,260 kg. The traveling distance until the tire failed was measured. When defining the traveling distance of the Comparative Example 1 as 100, the tires were evaluated using indexes. The larger index indicates the superior durability of the belt layer.

### (3) Anti Irregular Wear Performance

After running 80,000 km on a dry road surface, volume of irregular wear was measured in the tread portion. When defining the inverse number of irregular wear amount in the Comparative Example 1 as 100, the tires were evaluated using indexes. The larger index indicates the superior anti irregular wear performance of the tire.

### Examples 1 to 7, Comparative Example 3

The heavy load pneumatic tires each provided with the belt layer shown in FIG. 1 were prepared. The heavy load pneumatic tire includes a first reinforcement belt (length L₁ in the width direction of the tire), which has belt cords arranged at an angle of 0° with respect to circumferential direction of the tire; a first function belt (length 260 mm in the width direction of the tire), which has belt cords arranged at an angle of 17° right-upward with respect to the circumferential direction of the tire as viewed from the tread surface; a second reinforcement belt (length: 220 mm in the width direction of the tire), which has belt cords arranged at an angle of 0° with respect to the circumferential direction of the tire; a second function belt (length: 240 mm in the width direction of the tire), which has belt cords arranged at an angle of 17° left-upward with respect to the circumferential direction of the tire as viewed from the tread surface; and a protection belt (length: 200 mm in the width direction of the tire), which has belt cords arranged at an angle of 20° right-upward with respect to the circumferential direction of the tire as viewed from the tread surface. The respective lengths were set to the values indicated in the upper rows of Table 1; i.e., as viewed in the width direction of the tire, the length “L₁” of the first reinforcement belt; the length “Wᵣₛ” from the outer end of the first reinforcement belt to the tire equator; the length “W_{w}” from the outer end of the function belt having the shorter length in the first and second function belts to the tire equator; the length “Wᵣ” from the outer end of the second reinforcement belt to the tire equator; and the length “Wₚ” from the outer end of the protection belt to the tire equator. The result of the performance evaluation made using the respective tires is indicated in the lower rows of Table 1.

### Comparative Example 1

A heavy load pneumatic tire, which has the same belt layer as the belt layer (first function belt, second reinforcement belt, second function belt and protection belt) shown in FIG. 1 except that the first reinforcement belt is not provided, was prepared. In Comparative Example 1, “W_{w}”, “Wᵣ” and “Wₚ” were set to the value indicated in the upper row of Table 1 respectively. The result of the performance evaluation conducted using the tire is shown in the lower rows of Table 1 below.

### Comparative Example 2

A heavy load pneumatic tire, which has the same belt layer as the belt layer (first function belt, second reinforcement belt (two), second function belt and protection belt) shown in FIG. 1 except that the first reinforcement belt is not provided and two second reinforcement belts are provided being overlapped with each other, was prepared. In Comparative Example 2, “W_{w}”, “Wᵣ” and “Wₚ” were set to the value indicated in the upper rows of Table 1. The result of the performance evaluation made using the tire is shown in the lower rows of Table 1 below.

TABLE 1

| | Comparative | Comparative | Example | Example | Example | Example | Example | Example | Example | Comparative |
|---|---|---|---|---|---|---|---|---|---|---|
| | Example 1 | Example 2 | 1 | 2 | 3 | 4 | 5 | 6 | 7 | Example 3 |
| Lₗ | — | — | 24 | 36 | 48 | 60 | 72 | 84 | 48 | 48 |
| Wᵣₛ | — | — | 115 | 115 | 115 | 115 | 115 | 115 | 115 | 110 |
| W_{w} | 120 | 120 | 120 | 120 | 120 | 120 | 120 | 120 | 120 | 120 |
| Wᵣ | 110 | 110 | 110 | 110 | 110 | 110 | 110 | 110 | 110 | 115 |
| Wₚ | 100 | 100 | 100 | 100 | 100 | 100 | 100 | 100 | 100 | 100 |
| L_{l/}W_{w} | — | — | 0.2 | 0.3 | 0.4 | 0.5 | 0.6 | 0.7 | 0.4 | 0.4 |
| Tire weight | 100 | 120 | 104 | 106 | 108 | 110 | 112 | 114 | 108 | 108 |
| Durability | 100 | 116 | 102 | 108 | 112 | 114 | 116 | 116 | 112 | 96 |
| Anti | 100 | 121 | 115 | 122 | 128 | 131 | 126 | 121 | 128 | 129 |
| irregular | | | | | | | | | | |
| wear | | | | | | | | | | |
| performance | | | | | | | | | | |

The results shown in Table 1 demonstrate that, compared to the heavy load pneumatic tire of the Comparative Example 1, the heavy load pneumatic tires of Examples 1 to 7 are superior in both of the durability of the belt layer and the anti irregular wear performance. Particularly, it is demonstrated that the heavy load pneumatic tires of Examples 2 to 5, in which the length was set so as to be 0.3≦L₁/W_{w}≦0.6, are particularly superior in both of the durability of the belt layer and the anti irregular wear performance while the total weight of the tire is reduced. On the other hand, in the heavy load pneumatic tire of the Comparative Example 2, since double second reinforcement belts were provided, the total weight of the tire was increased. Furthermore, the Comparative Example 2 is inferior to the heavy load pneumatic tires of Examples 2 to 5 in the anti irregular wear performance.

Comparing the heavy load pneumatic tire of Example 7 and the heavy load pneumatic tire of the Comparative Example 3, only the relation of “Wᵣₛ” and “Wᵣ” is different therebetween. In the heavy load pneumatic tire of the Comparative Example 3, since the values were set so as to be Wᵣ>Wᵣₛ, compared to the heavy load pneumatic tire of Example 1, it is demonstrated that the durability of the belt layer is considerably reduced.

What is claimed is:

1. A heavy load pneumatic tire including:
a carcass layer with both ends rolled back at a pair of circular beads, and
a belt layer disposed outside of the carcass layer as viewed in a radial direction of the tire so as to reinforce the carcass layer, said belt layer including:
a first reinforcement belt that is located innermost thereof as viewed in a radial direction of the tire, is separated into two parts each of which is disposed at both sides of a tire equator and is spaced apart from each other, and has belt cords arranged in a circumferential direction of the tire,
a first function belt that is disposed outside of the first reinforcement belt as viewed in the radial direction of the tire and has belt cords arranged at an angle of 10 to 30° with respect to the circumferential direction of the tire,
a second reinforcement belt that is disposed outside of the first function belt as viewed in the radial direction of the tire and has belt cords arranged in the circumferential direction of the tire, and
a second function belt that is disposed outside of the second reinforcement belt as viewed in the radial direction of the tire and has belt cords arranged at an angle of 10 to 30° with respect to the circumferential direction of the tire and in a direction opposite to an inclination direction of the belt cords of the first function belt,
wherein, when defining, as viewed in the width direction of the tire, the length from the outer end of the first reinforcement belt to a tire equator as “Wᵣₛ”, the length from the outer end of the function belt having the shorter length in the first and second function belts to the tire equator as “W_{w}”, and the length from the outer end of the second reinforcement belt to the tire equator as “Wᵣ”, the lengths are set so as to be Wᵣ<Wᵣₛ<W_{w}.

2. The heavy load pneumatic tire according to claim 1,
wherein, when defining, as viewed in the width direction of the tire, the length of the first reinforcement belt as “L₁”, the length is set so as to be 0.3≦L₁/W_{w}≦0.6.

3. The heavy load pneumatic tire according to claim 1, wherein the belt layer further includes a protection belt that is disposed at the outermost side thereof as viewed in the radial direction of the tire and has belt cords arranged at an angle of 10 to 30° with respect to the circumferential direction of the tire, the outer end of the protection belt as viewed in the width direction of the tire is located at the position outer than the main groove located at the outermost side of the tread portion as viewed in the width direction of the tire, and when defining, as viewed in the width direction of the tire, the length from the outer end of the protection belt to the tire equator as “Wₚ”, the length is set so as to be Wₚ<Wᵣ.
